(19) United States
(12) Patent Application Publication
(10) Pub. No.: US 2026/0086443 A1
(43) Pub. Date: Mar. 26, 2026

(54) SINGLE, SUPPORT ARMATURE CAMERA TOWER INCLUDING POSITIONAL ADJUSTMENT ASSEMBLIES

(71) Applicant: Idemia Identity & Security USA LLC, Reston, VA (US)

(72) Inventors: Harshad R. Thacore, Bedford, MA (US); Brian Bresnahan, Waltham, MA (US); Daniel Brown, Bellingham, MA (US); Etim Nduonyi, Eden Prairie, MN (US); Yasmin Nabavi, Anaheim, CA (US); Amy Potts, Westford, MA (US); Derek Riemer, Westford, MA (US)

(21) Appl. No.: 19/202,775

(22) Filed: May 8, 2025

Related U.S. Application Data
(63) Continuation-in-part of application No. 18/892,172, filed on Sep. 20, 2024.

(51) Int. Cl. G03B 17/56; G03B 17/55

(52) U.S. Cl. CPC G03B 17/561; G03B 17/55

(57) ABSTRACT

A camera mount assembly comprises a support armature, a frame including an aperture formed therethrough, and a camera housing connected to the support armature and configured to at least partially surround the frame. The camera housing including an aperture formed therethrough. The camera mount assembly further including a positional adjustment assembly coupled to the frame. The positional adjustment assembly including a hub assembly comprising an inner portion and an outer portion having an inner surface, the inner portion extending at least partially through the apertures of the frame and the camera housing. The positional adjustment assembly further including a first spring component positioned at least partially within said support armature and configured to resist movement of the frame and the camera housing along the support armature

### CROSS-REFERENCE TO RELATED APPLICATIONS

This application is a continuation-in-part application of U.S. patent application Ser. No. 18/892,172, filed Sep. 20, 2024, the entire content and disclosure of which are hereby incorporated herein by reference in its entirety.

### FIELD

The field of the disclosure relates generally to camera tower systems and more specifically, to single, support armature camera towers that include positional adjustment assemblies for adjusting both the height and angular tilt of a camera for the camera tower.

### BACKGROUND

Previous approaches to camera housings have typically involved fixed structures that do not allow for easy adjustment of the camera's position or orientation. These fixed structures often limit the user's ability to customize the camera's angle or height, resulting in restricted flexibility in capturing desired images or videos. Some camera housings have incorporated limited adjustment mechanisms, such as manual screws or knobs, to allow for minor changes in the camera's position. However, these mechanisms are often cumbersome to operate and do not provide a wide range of adjustment options.

In certain instances, camera housings have utilized complex mechanical systems involving multiple moving parts to enable adjustments in height or tilt angle. These conventional systems have included gears, levers, and/or motors to facilitate precise positioning of the camera. While these mechanisms offer increased adjustability, they are often bulky, expensive to manufacture, and prone to mechanical failures overtime. Additionally, the complexity of these systems may require specialized knowledge or tools for installation and operation, limiting their practicality for everyday users.

Other camera housings have attempted to address the limitations of fixed structures by incorporating a plurality of brackets or armatures that allow for some degree of adjustment. However, these solutions are often limited in their range of motion and may not provide sufficient stability or precision in adjusting the camera's position. Furthermore, the additional components required for these mounting systems can add bulk and weight to the overall camera setup, potentially impacting portability and ease of use.

### BRIEF DESCRIPTION

One aspect includes a camera mount assembly comprising a support armature, a frame including an aperture formed therethrough, and a camera housing connected to the support armature and configured to at least partially surround the frame. The camera housing including an aperture formed therethrough. The camera mount assembly further including a positional adjustment assembly coupled to the frame. The positional adjustment assembly including a hub assembly comprising an inner portion and an outer portion having an inner surface, the inner portion extending at least partially through the apertures of the frame and the camera housing. The positional adjustment assembly further including a first spring component positioned at least partially within said support armature and configured to resist movement of the frame and the camera housing along the support armature.

Another aspect includes a camera tower comprising a base assembly including a bottom plate and a camera mount assembly. The camera mount assembly comprising a support armature, a frame including an aperture formed therethrough and a camera housing connected to the support armature and configured to at least partially surround the frame. The camera housing including an aperture formed therethrough. The camera mount assembly further including a positional adjustment assembly coupled to the frame. The positional adjustment assembly including a hub assembly comprising an inner portion, an outer portion having an inner surface, and a disc spring. The inner portion extending at least partially through the apertures of the frame and the camera housing. The disc spring contacts the outer portion inner surface and the frame. A spring component is positioned at least partially within the support armature and is configured to resist movement of the frame and the camera housing along the support armature.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a perspective view of a camera tower including a camera mount assembly;

FIGS. 1B and 1C are partially exploded, perspective views of the camera tower of FIG. 1A;

FIG. 1D is a cross-sectional, perspective view of a portion of the camera tower taken along line 1D-1D in FIG. 1A;

FIG. 1E is a cross-sectional, side view of a portion of the camera tower taken along line 1E-1E in FIG. 1A;

FIG. 2A is an exploded, perspective view of a portion of the camera mount assembly for the camera tower of FIG. 1A;

FIG. 2B is an exploded, perspective view of a positional adjustment assembly included in the camera mount assembly of FIG. 2A;

FIG. 2C is a cross-sectional, back view of a portion of the camera mount assembly taken along line 2C-2C in FIG. 1A;

FIG. 3 is back view of a portion of the camera tower of FIG. 1A; and

FIG. 4 is a front view of a tilt plate for a positional adjustment assembly.

FIG. 5A is a perspective view of a camera tower including a camera mount assembly;

FIGS. 5B and 5C are partially exploded, perspective views of the camera tower of FIG. 5A;

FIG. 5D is a perspective view of a support armature including some components of a positional adjustment assembly of the camera tower shown in FIG. 5A.

FIG. 5E is a cross-sectional, side view of a portion of the camera tower taken along line 5E-5E in FIG. 5A;

FIG. 6A is an exploded, perspective view of a portion of the camera mount assembly for the camera tower of FIG. 5A;

FIG. 6B is an exploded, perspective view of a positional adjustment assembly included in the camera mount assembly of FIG. 6A;

FIG. 7 is a perspective view of a friction slider shown in FIG. 6A including a pair of spring pads;

FIG. 8 is a perspective view of a heat spreader of the camera tower shown in FIG. 5A with an exploded top portion.

FIG. 9 is a partially exploded view of the heat spreader shown in FIG. 5F.

FIG. 10A is a perspective view of the hub assembly shown in FIG. 6B.

FIG. 10B is an exploded view of the hub assembly shown in FIG. 10A.

### DETAILED DESCRIPTION

The disclosed assemblies, apparatuses, and systems provide for improved image capturing, accessibility, and adjustability for camera towers. These assemblies, apparatuses, and systems may be implemented in locations where images are regularly and repeatedly captured but require constant operational adjustments due to environmental circumstances (e.g., height of image subject, size of image subject, distance from camera, etc.), such as at security checkpoints (airports, border crossings, government buildings, etc.) and/or official government Identification facilities (e.g., department of motor vehicles, passport photograph sites, etc.).

It should be understood that any values and thresholds described herein may be different in various implementations of assisted enrollment proctoring system, or even in different instances of the process performed by a same assisted enrollment proctoring system. Although discussed herein with reference to assisted enrollment, it is to be understood that the systems may be utilized by self-enrollment proctoring systems. The example values, thresholds, and computations provided herein may optimize the precision and accuracy of any determinations and may further optimize the computational loading of the processor on which the module is implemented, but the disclosed systems and methods may operate with various other parameters without departing from the scope of the disclosure. The examples that follow, with respect to the figures, are illustrative and should not be construed in a limiting manner.

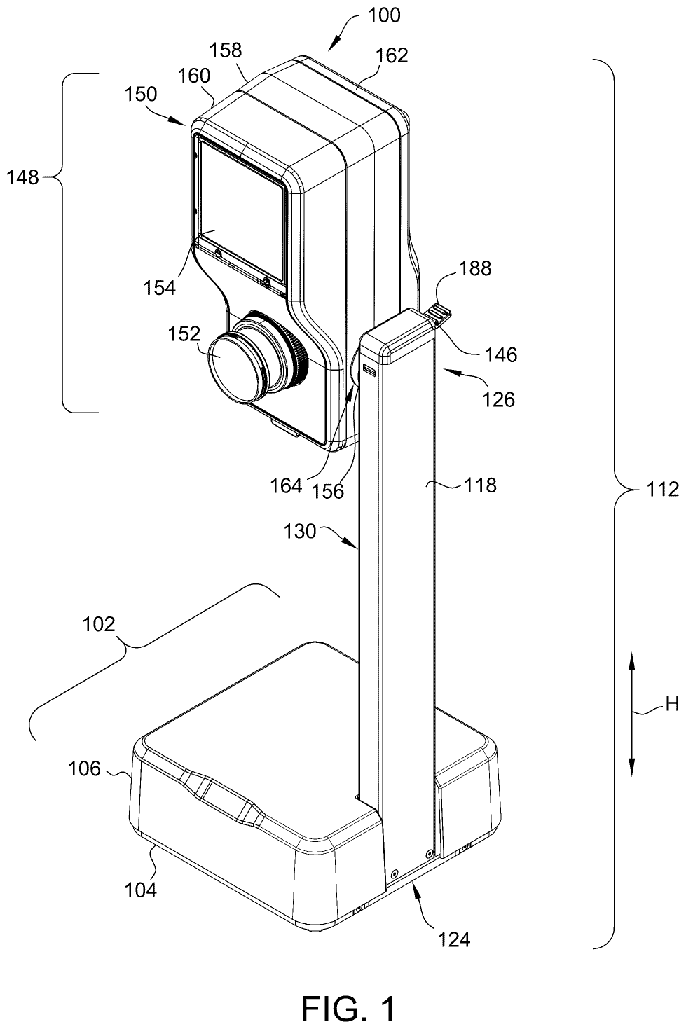

FIGS. 1A, 1B, 1C, 1D, and 1E show various views of a camera tower or camera tower system 100 (hereafter, “camera tower 100”). Specifically, FIG. 1A is a perspective view of camera tower 100 and FIGS. 1B and 1C are partially exploded, perspective views of camera tower 100. Additionally, FIG. 1D is a cross-sectional, perspective view of a portion of camera tower 100 taken along line 1D-1D in FIG. 1A, while FIG. 1E is a cross-sectional, sideview of a portion of camera tower 100 taken along line 1E-1E in FIG. 1A. As discussed herein, portions of camera tower 100 are adjustable to alter the height and/or angular tilt of a camera for improving picture capturing capabilities, while reducing an overall footprint of camera tower 100.

Camera tower 100 includes a base assembly 102. Base assembly 102 provides support and stabilizes camera tower 100 during operation. In non-limiting examples shown in FIGS. 1A-1C, base assembly 102 includes a bottom plate 104 positioned adjacent a surface (not shown) in which camera tower 100 is positioned on and/or over, and a cover 106 coupled to bottom plate 104. Bottom plate 104 is formed from any suitable material and/or component configured to support various components of camera tower 100 and/or provide stability to camera tower 100 during operation. For example, bottom plate 104 is formed from a material including, but not limited to, metal, metal alloy, polymer, ceramic material, or the like.

Cover 106 is coupled to and/or positioned over or on bottom plate 104 to define a space between bottom plate 104 and cover 106 of base assembly 102. The space defined between cover 106 and bottom plate 104 can house and/or receive a plurality of components of camera tower 100. For example, and as shown in FIG. 1B, a plurality of electronic components 108 are positioned between bottom plate 104 and cover 106. M ore specifically, the plurality of electronic components 108 are disposed over and/or coupled to a substrate 110 coupled to and/or positioned on bottom plate 104, opposite cover 106. During operation of camera tower the plurality of electronic components 108 are substantially covered, enveloped, and/or protected by cover 106. The plurality of electronic components 108 of camera tower 100 can be formed as any suitable components to aid in the operation of camera tower 100. For example, the plurality of electronic components 108 can include, but are not limited to, a power supply or power converter, a memory device for storing images captured by a camera of camera tower 100, a device connection hub or multiport (e.g., universal serial bus (USB)), and similar electronic components. In exemplary embodiments, the device connection hub includes a plurality of USB and/or USB type-C ports for connecting a plurality of devices to camera tower 100.

In exemplary embodiments shown in FIGS. 1A-1C and 1E, camera tower 100 also includes a camera mount assembly 112 coupled to base assembly 102. Camera mount assembly 112 includes a single, support armature 118 extending from base assembly 102. M ore specifically, camera mount assembly 112 includes a single, support armature 118 extending substantially perpendicular from and/or releasably coupled to bottom plate 104 of base assembly 102. As shown in FIGS. 1A and 1B, cover 106 of base assembly 102 includes a recess 120 for receiving and/or being disposed around at least a portion of single, support armature 118 when single, support armature 118 is coupled to and/or extending from base assembly 102. Single, support armature 118 is formed from any suitable material that is capable of supporting distinct components of camera mount assembly 112 for camera tower 100. For example, single support armature 118 is formed from a material including, but not limited to, metal, metal alloy, polymer, ceramic material, or the like.

Single, support armature 118 of camera mount assembly 112 includes an opening 122 extending therethrough. That is, and in exemplary embodiments where single, support armature 118 is formed as a substantially tubular component, single, support armature 118 includes opening 122 extending therethrough and/or extending between a first end 124 and a second end 126 of single, support armature 118. Opening 122 formed in single, support armature 118 is configured to receive various components of camera tower 100, as discussed herein. Additionally, single, support armature 118 also includes a slot 128 formed in a sidewall 130. M ore specifically, and as shown in FIG. 1C, slot 128 is formed through at least a portion of sidewall 130 adjacent second end 126 of single, support armature 118. As discussed herein, slot 128 receives a distinct component of camera mount assembly 112 to facilitate the positional adjustment and/or movement of distinct portions of camera tower 100 during operation.

In exemplary embodiments, camera mount assembly 112 also includes a support plate 132 coupled to single, support armature 118. Support plate 132 is releasably coupled to first end 124 of single, support armature 118, opposite second end 126 and/or slot 128 formed through at least a portion of sidewall 130. For example, and as shown in FIGS. 1B and 1C, first end 124 of single, support armature 118 is releasably coupled and/or affixed to a bracket 134 included on and/or formed integral with support plate 132. Additionally, support plate 132 is releasably coupled to and/or positioned on bottom plate 104 of base assembly 102. In the non-limiting example shown in FIGS. 1B and 1C, support plate 132 is positioned within, received by, and/or adjacent to a notch 136 formed in substrate 110 to facilitate the releasable coupling of support plate 132 directly to substrate 110 of base assembly 102. A s discussed herein, releasably coupling support plate 132 to bottom plate 104 facilitates the complete assembling of camera mount assembly 112 separate from base assembly 102 and/or increases the ability to perform maintenance on different components of camera mount assembly 112 by uncoupling support plate 132 from bottom plate 104. Support plate 132 is releasably coupled to bottom plate 104 of base assembly 102 using any suitable coupling technique and/or mechanism. Additionally, single, support armature 118 is releasably coupled to bracket 134 of support plate 132 using any suitable coupling technique and/or coupling mechanism including, but not limited to, screws, nuts-and-bolts, snap fits, pins, and the like.

Camera mount assembly 112 further includes a slidable mount 138 disposed within said single, support armature 118. For example, and as discussed herein, slidable mount 138 is disposed within and/or positioned inside of opening 122 of support armature 118. Slidable mount 138 is also positioned adjacent to and/or substantially aligned with slot 128 formed through sidewall 130, adjacent second end 126 of single, support armature 118. As shown in FIG. 1D, slidable mount 138 includes a coupling portion 139 that extends through slot 128 of single, support armature 118 to facilitate the coupling of various components of camera mount assembly 112. That is, and as discussed herein, coupling portion 139 of slidable mount 138 extends through slot 128, adjacent to and/or outside of opening 122 of single, support armature 118, and is configured to be coupled to distinct components (e.g., positional adjustment assembly) of camera mount assembly 112.

Additionally, and as discussed herein, slidable mount 138 is configured to move within opening 122 of single, support armature 118 to adjusting the height (H) of distinct components of camera mount assembly 112 relative to base assembly 102. Coupling portion 139 of slidable mount 138 is also configured to selectively move within slot 128 of single, support armature 118 when adjusting the height (H) of distinct components of camera mount assembly 112. In the non-limiting example shown in FIG. 1D, and as discussed herein, slot 128 is formed through a portion of sidewall 130 and/or does not extend through sidewall 130 adjacent second end 126. As a result of coupling portion 139 extending through slot 128, the length or size of slot 128 and/or coupling portion 139 extending through slot 128 limits and/or restricts the height range in which components of camera tower 100 are adjusted. In other non-limiting examples, slot 128 can extend through the entire length of single, support armature 118 to provide increased adjustment to the height (H), as discussed herein. To facilitate the sliding of slidable mount 138 within opening 122 of single, support armature 118, slidable mount 138 including coupling portion 139 is formed from any suitable material that includes a low coefficient of friction with single, support armature 118. Additionally, slidable mount 138 is also formed from a substantially rigid material to provide support to various components of camera mount assembly 112, as discussed herein. For example, slidable mount 138 is formed from metal, metal alloys, polymer, ceramic, fibrous material (e.g., fiberglass), and the like.

A chain 140 of camera mount assembly 112 is coupled to slidable mount 138. M ore specifically, chain 140 is disposed within, extends through, and/or is positioned inside of opening 122 of support armature 118 and is coupled and/or affixed to slidable mount 138. In a non-limiting example shown in FIG. 1B, a first end 142 of chain 140 is coupled directly to slidable mount 138, while a second end 144 of chain 140, opposite first end 142, is coupled and/or affixed to bracket 134 of support plate 132. In other exemplary embodiments, second end 144 of chain 140 is fixed directly to support plate 132 and/or support armature 118, adjacent second end 126. Additionally, and as shown in FIG. 1E, chain 140 is wrapped around, and/or substantially bends around slidable mount 138 within camera tower 100. To facilitate the bending of chain 140, and/or to prevent slidable mount 138 and chain 140 from being removed from support armature 118 during operation, an end cap 146 is coupled to support armature 118. As discussed herein chain 140, and more specifically first end 142 of chain 140, is configured to selectively move within single, support armature 118, in conjunction with slidable mount 138, in response to adjusting the height (H) of distinct components of camera mount assembly 112 relative to base assembly 102. That is, and as a result of first end 142 of chain 140 being coupled directly to slidable mount 138, first end 142, and adjacent portions of chain 140 are configured to selectively move, along with slidable mount 138, within single, support armature 118 when adjusting the height (H) of distinct components of camera mount assembly 112. Chain 140 is formed as energy chain. . . . However, it is understood that chain 140 can be formed from any suitable grouping mechanism and/or device that is configured to move within support armature 118 and/or housing wires for various components of camera tower 100, as discussed herein. Chain 140 is formed from any suitable material and/or component configured to move within support armature 118 during operation. For example, chain 140 is formed from a material including, but not limited to, metal, metal alloy, polymer, ceramic material, braided fibers/fibrous material, or the like.

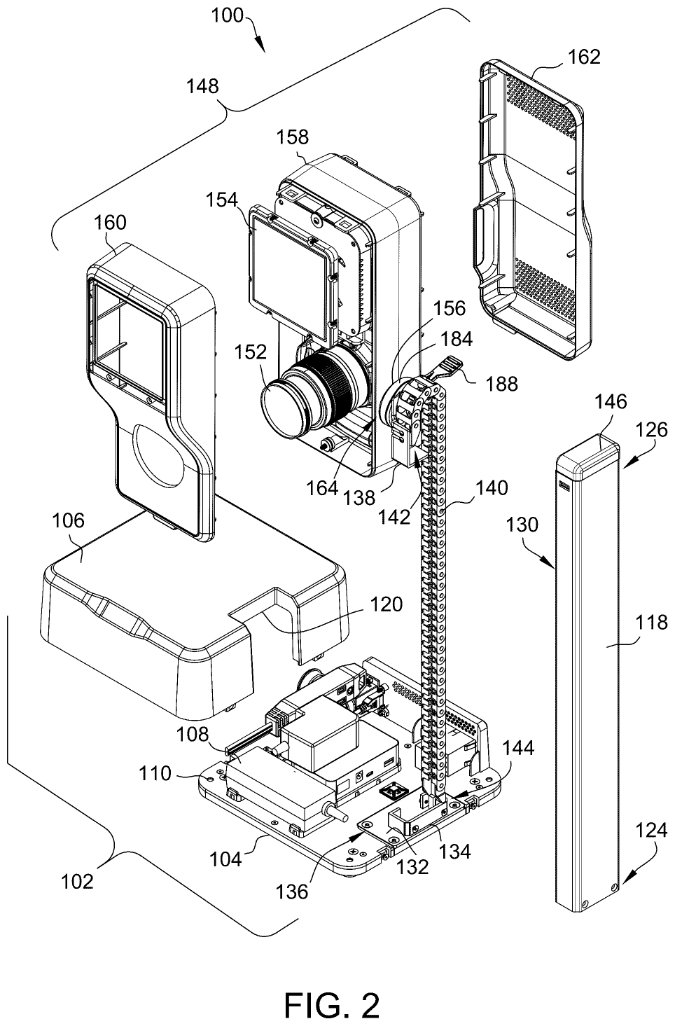

Furthermore, chain 140 is configured to house, protect, and/or restrict movement of wires or physical electrical connections (see, FIG. 2C) for the camera and/or flash component included within camera tower 100. In exemplary embodiments, chain 140 includes a break, discontinuity, and/or “zipper” 147 (hereafter, “break 147”) in a portion of each of the links forming chain 140. Breaks 147 of chain 140 provide access to an internal cavity defined by and/or within each link. For example, and as shown in FIGS. 1C and 1D, breaks 147 are formed on an inner portion of each link for chain 140. Breaks 147 provide improved and/or ease of access to the internal cavity defined by the links of chain 140, such that wires and/or electrical connections coupled to the camera and/or flash component and plurality of electronic components 108 housed in base assembly 102 can be disposed within and/or extend through support armature 118 within chain 140. Additionally, or alternatively, housing the wires of camera tower 100 within chain 140 substantially prevents and/or reduces the risk of the wires obstructing the movement of slidable mount 138 within single, support armature 118 during operation of camera tower 100, as discussed herein.

As shown in FIGS. 1A-1C, camera mount assembly 112 also includes a camera housing 148 coupled to slidable mount 138. Camera housing 148 of camera mount assembly 112 is also positioned adjacent single, support armature 118 of camera tower 100. In exemplary embodiments, camera housing 148 includes an outer shell 150 surrounding, circumscribing, and/or housing at least a portion of a camera 152 and/or a flash device 154, respectively. Outer shell 150 of camera housing 148 includes an aperture 156 formed therethrough. M ore specifically, and as shown in FIGS. 1B and 1C, outer shell 150 includes a sidewall portion 158 including aperture 156 formed therethrough, where aperture 156 is substantially adjacent to and/or aligned with single, support armature 118. Additionally in the non-limiting example, outer shell 150 of camera housing 148 also includes a front portion 160 releasably coupled to sidewall portion 158, and a back portion 162 releasably coupled to sidewall portion 158, opposite front wall portion 160. Releasably coupling front portion 160 and/or back portion 162 of outer shell 150 provides increased access and/or ease of accessibility to camera 152 and/or flash device 154 to perform maintenance and/or exchange parts of components within camera tower 100 during operation. Outer shell 150 is formed from any suitable material that protects and/or supports camera 152 and/or flash device 154 during operation of camera tower 100.

Camera mount assembly 112 also includes a positional adjustment assembly 164 coupled to outer shell 150 of camera housing 148. As shown in FIGS. 1A-1C, at least a portion of positional adjustment assembly 164 is also positioned between outer shell 150 and single, support armature 118. As discussed herein, positional adjustment assembly 164 is configured to adjust the height (H) of outer shell 150 of camera housing 148 relative to base assembly 102, and/or adjust angular tilt (α) (see, FIG. 1E) relative to single, support armature 118 during operation or use of camera tower 100.

With continued reference to FIGS. 1A-1E, FIGS. 2A, 2B, and 2C show various views of various components of camera tower 100 including positional adjustment assembly 164. M ore specifically, FIG. 2A shows an exploded, perspective view of a portion of the components forming camera tower 100 including positional adjustment assembly 164, and FIG. 2B shows an exploded, perspective view of slidable mount 138 and positional adjustment assembly 164. Additionally, FIG. 2C is a cross-sectional, back view of a portion of camera tower 100 taken along line 2C-2C in FIG. 1A. FIGS. 2A and 2C omit camera 152 and flash device 154 for the sake of clarity. Furthermore, it is understood that similarly numbered and/or named components may function in a substantially similar fashion. Redundant explanation of these components has been omitted for clarity.

Positional adjustment assembly 164 of camera housing 148 includes a hub component 166 extending through aperture 156 formed through sidewall portion 158 of outer shell 150. More specifically, and as shown in FIG. 2C, at least a portion of hub component 166 extends through aperture 156 formed through sidewall portion 158, such that a first end 168 of hub component 166 is positioned within body portion 158 and/or substantially adjacent aperture 156. In exemplary embodiments, at least a portion of first end 168 is also positioned within an internal cavity (C) defined by outer shell 150. Additionally, a second end 170 of hub component 166, position opposite first end 168, is positioned outside of and/or adjacent body portion 158 of outer shell 150. Second end 170 of hub component 166 is also positioned adjacent to and/or abuts single, support armature 118. In exemplary embodiments shown in FIGS. 2B and 2C, second end 170 of hub component 166 includes opposing tabs 172 positioned opposing one another. Tabs 172 of hub component 166 are sized and/or configured to be positioned within and/or engage slot 128 formed through sidewall 130 of single, support armature 118. In the exemplary embodiment, positioning, disposing and/or engaging tabs 172 of hub component 166 within slot 128 substantially prevents undesirable rotation of hub component 166, and additional components of positional adjustment assembly 164 coupled thereto, during operation of camera tower 100. Additionally, and as discussed herein, tabs 172 of hub component 166 are disposed, positioned, and/or engaged within slot 128 to guide the movement of various components of camera tower 100 with respect to support armature 118. Although two opposing tabs 172 are shown, it is to be understood that hub component 166 can include more or less tabs 172 for being disposed within slot 128 during operation.

Hub component 166 is formed as a substantially tubular component. In non-limiting examples shown in FIG. 2C, at least a portion of tubular hub component 166 is disposed around, circumscribes, and/or envelops coupling portion 139 of slidable mount 138 when coupling positional adjustment assembly 164 to slidable mount 138. Additionally, and as discussed herein, hub component 166 is releasably coupled to coupling portion 139 of slidable mount 138 within camera mount assembly 112 of camera tower 100. Hub component 166 of positional adjustment assembly 164 is formed from any suitable material that supports the connection and/or coupling of hub component 166 to the various components of camera mount assembly 112/camera housing 148, as discussed herein. For example, hub component 166 is formed from a material including, but not limited to, metal, metal alloy, polymers, ceramics, fibrous materials, and the like.

Positional adjustment assembly 164 also includes a tilt plate 174 coupled to hub component 166. M ore specifically, and as shown in FIG. 2C, tilt plate 174 is coupled to and positioned adjacent first end 168 of hub component 166. Tilt plate 174 is also positioned and/or disposed within internal cavity (C) defined by outer shell 150 of camera housing 148, adjacent to and substantially aligned with aperture 156 formed through sidewall portion 158. As shown in FIG. 2C, tilt plate 174 also abuts, contacts, and/or is positioned directly adjacent an inner surface of outer shell 150, and more specifically sidewall portion 158 of outer shell 150. In the non-limiting example shown in FIGS. 2A and 2B, a coupling mechanism (e.g., screws) is shown as extending through tilt plate 174 and hub component 166, and in turn coupling tilt plate 174 and hub component 166 to coupling portion 139 of slidable mount 138. M ore specifically, a plurality of screws pass through, and in turn, couple tilt plate 174, hub component 166, and slidable mount 138 to one another within camera tower 100. In other non-limiting examples, tilt plate 174 can be coupled to hub component 166 independent of slidable mount 138, and vice versa.

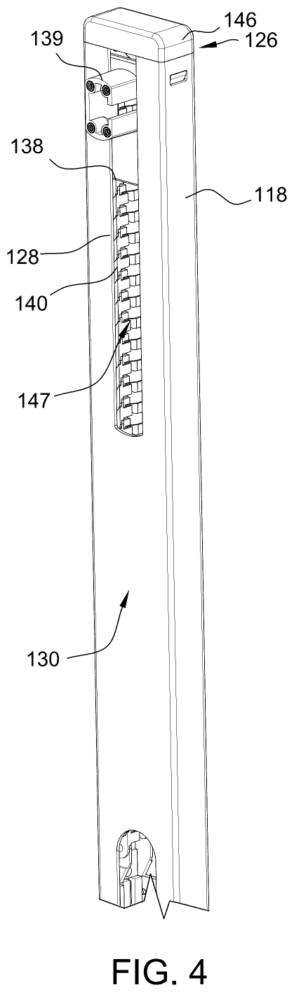

Tilt plate 174 is configured to and/or facilitates the angular tilt of outer shell 150 for camera housing 148. That is, tilt plate 174 includes at least one tilt feature 176 that facilitates adjustment of the angular tilt of outer shell 150 for camera tower 100 during operation. In the non-limiting example shown in FIGS. 2A-2C, tilt feature 176 of tilt plate 174 includes a plurality of fanned notches 178 formed on a surface of tilt plate 174, adjacent to hub component 166. In the exemplary embodiment, tilt plate 174 includes five (5) distinct notches 178 spaced apart and/or oriented with respect to one another such that during operation, the angular tilt for outer shell 150 can be adjusted between +30° and −30°. As such, each adjacent notch 178 may determine, define, and/or distinguish a 15° angular tilt difference for outer shell 150, where the third or middle notch 178 defines and/or positions outer shell 150 in a 0° angular tilt when engaged during operation of camera tower 100. Although five (5) notches 178 are shown, it is understood that tilt plate 174 can include more or less notches forming tilt feature 176 (see, FIG. 4). Similar to hub component 166 of positional adjustment assembly 164, tilt plate 174 is formed from any suitable material that facilitates the adjustment of the angular tilt of camera housing 148, as discussed herein. For example, tilt plate 174 is formed from a material including, but not limited to, metal, metal alloy, polymers, ceramics, fibrous materials, and the like. Additionally, although discussed herein as ranging from +30° and −30° and/or being adjustable by 15° increments, it is understood that the plurality of notches 178 included in tilt plate 174 can be larger, smaller, and/or include a distinct spacing to increase or decrease the angular tilt range achievable by outer shell 150.

To secure and/or maintain the angular tilt (α) (see, FIG. 1E) of outer shell 150 for camera housing 148, camera housing 148 includes additional components to engage and/or interact with tilt plate 174 of positional adjustment assembly 164. For example, and as shown in FIGS. 2A and 2C, camera housing 148 also includes securing component 180 coupled to and/or formed within outer shell 150. M ore specifically, securing component 180 is positioned within and/or extends through a distinct aperture 182 formed through sidewall portion 158 of outer shell 150. Aperture 182 is positioned below aperture 156 configured to receive hub component 166 of positional adjustment assembly 164. As such, securing component 180 disposed within and/or extending through aperture 182 extends toward tilt plate 174 of hub component 166 and/or is substantially aligned with tilt feature 176 of tilt plate 174. In the exemplary embodiment shown in FIG. 2C, securing component 180 is configured to contact tilt feature 176, and more specifically each of the plurality of fanned notches 178, included in tilt plate 174 to secure and/or maintain outer shell 150 at a desired angular tilt (α) during operation of camera tower 100. Additionally, securing component 180 is also formed as any suitable component, apparatus, and/or device to facilitate the adjustment between distinct angles for the angular tilt (α) of outer shell 150 during operation of camera tower 100. A though discussed herein as being positioned within distinct aperture 182, it is to be understood that securing component 180 can be formed integral with and/or within sidewall portion 158 of outer shell 150.

In non-limiting examples, securing component 180 can include a spring loaded roller ball that is configured to be positioned within and/or engage the plurality of notches 178 included in tilt plate 174. That is, roller ball can be disposed within and/or contact one of the plurality of notches 178 in tilt plate 174 to maintain and/or securing outer shell 150 in a desired angular tilt (α), dependent upon the specific notch 178. Additionally, spring loaded roller ball can be “rolled out of” and/or at least partial compressed to roller over portions of tilt plate 174 formed between each of the plurality of notches 178 to when adjusting the angular tilt (α) of outer shell 150. As discussed herein, a user of camera tower 100 can apply a rotational force to outer shell 150 to adjust the angular tilt (α) using tilt plate 174 and securing component 180, respectively. Additionally, securing component 180, formed as a spring loaded roller ball, also provides tactile feedback (e.g., “Clicks”) to the user as they adjust the angular tilt (α) of outer shell 150 during operation. Although discussed herein as spring-loaded roller ball, securing component 180 can be formed as any suitable device, mechanism, and/or apparatus that is configured to facilitate the adjusting and maintaining of the angular tilt (α) of outer shell 150 during operation of camera tower 100. For example, securing component 180 can be formed as pin and/or screw that engages and/or contacts tilt plate 174 as similarly discussed herein.

Positional adjustment assembly 164 of camera housing 148 also includes an adjustment component 184 coupled to hub component 166. M ore specifically, adjustment component 184 is coupled to hub component 166 between first end 168 and second end 170, and positioned between and/or adjacent to single, support armature 118 and sidewall portion 158 of outer shell 150. As such, and as shown in FIG. 2C, adjustment component 184 is disposed outside of internal cavity (C) defined by outer shell 150 of camera housing 148 and/or proximate tilt plate 174. Additionally, and as shown in FIGS. 2A-2C, adjustment component 184 includes an opening 186 for receiving, circumferentially surrounding, and/or circumscribing at least a portion of hub component 166, between first end 168 and the second end 170, respectively. As a result of receiving and/or circumscribing hub component 166, adjustment component 184 is configured to rotate about hub component 166 and/or is selectively adjustable between a locked position and an unlocked position during operation of camera tower 100. As discussed herein, in the unlocked positioned, the height (H) and/or angular tilt (α) of outer shell 150 for camera tower 100 can be adjusted by a user. Alternatively, when adjustment component 184 of positional adjustment assembly 164 is in the locked position the height (H) and/or angular tilt (α) of outer shell 150 for camera tower 100 is maintained, locked, and/or unable to be adjusted.

As shown in the exemplary embodiments, adjustment component 184 includes a lever handle portion 188 to aid in the rotation and/or selective adjustment between the locked and unlocked position. However, it is understood that adjustment component 184 can include any distinct feature to aid in the rotation of adjustment component 184 during operation of camera tower 100, as discussed herein. Adjustment component 184 is formed from any suitable material that facilitates the selective adjustment of positional adjustment assembly 164 between the locked and unlocked position, as discussed herein. For example, adjustment component 184 is formed from a material including, but not limited to, metal, metal alloy, polymers, ceramics, fibrous materials, and the like.

In the non-limiting example shown in FIGS. 2A-2C, positional adjustment assembly 164 also includes a cam component 190 coupled to hub component 166. M ore specifically, cam component 190 is coupled to hub component 166 between first end 168 and second end 170, and positioned between and/or adjacent to single, support armature 118 and adjustment component 184. As such, and as shown in FIG. 2C, cam component 190 is disposed outside of internal cavity (C) defined by outer shell 150 of camera housing 148 and/or directly adjacent second end 170 of hub component 166 and single, support armature 118, respectively. Similar to adjustment component 184, and as shown in FIGS. 2A-2C, cam component 190 includes an opening 192 for receiving, circumferentially surrounding, and/or circumscribing at least a portion of hub component 166, between first end 168 and the second end 170, respectively. However, cam component 190 is not configured to rotate about hub component 166. In the exemplary embodiment, and similar to hub component 166, cam component 190 includes opposing tabs 194 positioned opposing one another. Tabs 194 of cam component 190 are sized and/or configured to be positioned within and/or engage slot 128 formed through sidewall 130 of single, support armature 118. In the exemplary embodiment, positioning, disposing and/or engaging tabs 194 of cam component 190 within slot 128 substantially prevents undesirable rotation of cam component 190 during operation of camera tower 100. Similar to adjustment component 184, cam component 190 is formed from any suitable material including, but not limited to, metal, metal alloy, polymers, ceramics, fibrous materials, and the like.

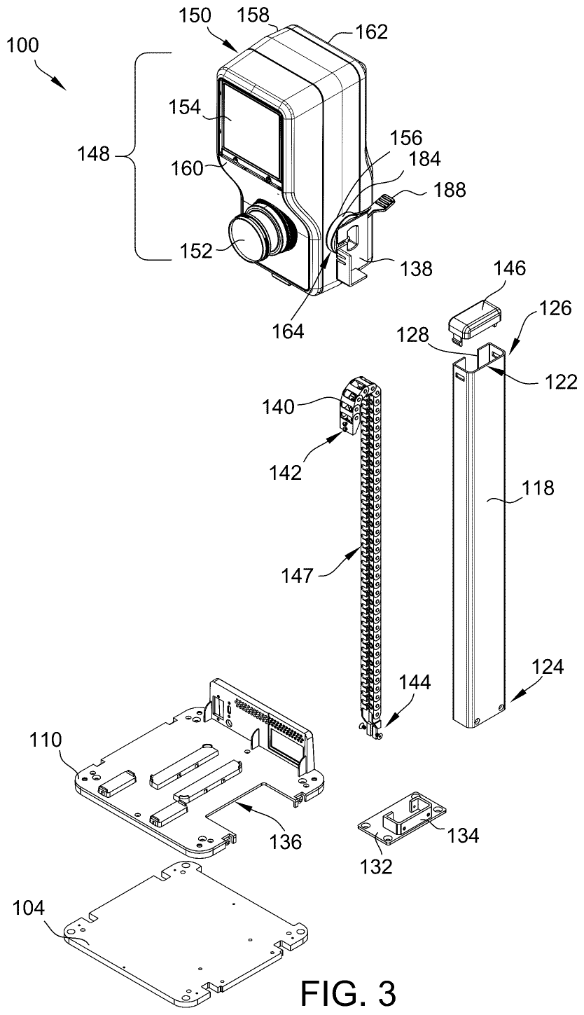

Cam component 190 facilitates the selective adjustment of adjustment component 184 between the locked position and the unlocked position during operation of camera tower 100. That is, the rotational movement of adjustment component 184, and in turn adjustment component's 184 mechanical and/or physical interaction with stationary cam component 190 facilitates positional adjustment assembly 164 being in either the locked position or the unlocked position. For example, and as shown in FIG. 2B, adjustment component 184 includes an end face 196 having a first geometry (G1). Additionally, cam component 190 includes an end face 198 positioned adjacent adjustment component 184 and/or end face 196 of adjustment component 184. End face 198 of cam component 190 includes a second geometry (G2) that is complimentary to the first geometry (G1) of end face 196 for adjustment component 184 in the unlocked position. That is, and as discussed herein (see, FIG. 3), when positional adjustment assembly 164 is in the unlocked position, the end faces 196, 198, and corresponding geometries (G1, G2) for adjustment component 184 and cam component 190 are complementary to facilitate and/or allow adjustments to the height (H) and/or angular tilt (α) of outer shell 150 for camera tower 100. As shown in the non-limiting example, each geometry (G1, G2) of respective faces 196, 198 are formed to include substantially waved/sinusoidal faces or surfaces. However, it is to be understood that the geometries (G1, G2) of respective faces 196, 198 can include any geometrically complimentary features and/or shapes.

As discussed herein, wires (not shown) connected to camera 152 and/or flash device 154 are at least partially housed within chain 140. That is, wires pass through a plurality of concentric and/or partially aligned holes formed in slidable mount 138, hub component 166 and tilt plate 174, respectively, and extend within internal cavity (C) defined by outer shell 150. Wires are mechanically and/or electrically connected to camera 152 and/or flash device 154 within outer shell 150 to provide power and/or transmit data/signals between the plurality of electronic components 108 and camera 152/flash device 154 during operation of camera tower 100.

FIG. 3 is back view of a portion of camera tower 100. FIG. 3 omits camera 152, flash device 154, and back portion 162 of outer shell 150 for the sake of clarity. Furthermore, it is understood that similarly numbered and/or named components may function in a substantially similar fashion. Redundant explanation of these components has been omitted for clarity.

In the exemplary embodiment shown in FIG. 3, and with continued reference to FIGS. 2A-2C, positional adjustment assembly 164 of camera housing 148 is depicted in an unlocked position. More specifically, end face 196 of adjustment component 184 including the first geometry (G1) is substantially aligned with and/or complementary with end face 198 of cam component 190 including the second geometry (G2). In the non-limiting example, a “peak” of the sinusoidal pattern of the second geometry (G2) for end face 198 of cam component 190 is substantially aligned with a “valley” of the complementary sinusoidal pattern of the first geometry (G1) for end face 196 of adjustment component 184. As a result of being in the unlocked position, positional adjustment assembly 164 does not apply a force (F1, F2) against single, support armature 118 and outer shell 150, respectively. As such, a user is free or capable of adjusting the height (H) of outer shell 150 by applying a directional force (D) to outer shell 150 to move slidable mount 138 within single, support armature 118. As a result of camera housing 148, and more specifically positional adjustment assembly 164 being coupled to both slidable mount 138 and outer shell 150, outer shell 150 moves with slidable mount 138 to adjust the height (H).

Additionally, or alternatively, when in the unlocked position, the angular tilt (α)(see, FIG. 1E) of outer shell 150 can also be adjusted. That is, and as a result of no force (F2) being applied to outer shell 150 by positional adjustment assembly 164, and more specifically adjustment component 184 in the unlocked position, a rotational force (e.g., in and out of the page) can be applied to outer shell 150 to adjust the angular tilt (α). As discussed herein, securing component 180 included in sidewall portion 158 of outer shell 150 also facilitates the adjusting and/or maintaining of the angular tilt (α) of outer shell 150 during operation of camera tower 100.

Alternatively in the locked position, positional adjustment assembly 164 imparts or applies a force (F1, F2) against single, support armature 118 and outer shell 150, respectively, to prevent adjustment and/or maintain the height (H) and/or angular tilt (α) of outer shell 150. For example, adjustment component 184 of FIG. 3 is rotated (e.g., into the page) about hub component 166 to selective move or adjust positional adjustment assembly 164 from the unlocked position to the locked position. In response to rotating adjustment component 184 about hub component 166 into the locked position, the geometries (G1, G2) of each end face 196, 198 for adjustment component 184 and cam component 190 are no longer complimentary. M ore specifically, rotating adjustment component 184 results in a “peak” of the sinusoidal pattern of the first geometry (G1) for end face 196 of adjustment component 184 being substantially aligned with and/or contacting a distinct “peak” of the sinusoidal pattern of the second geometry (G2) for end face 198 of cam component 190. This in turn causes adjustment component 184 and cam component 190 to apply forces (e.g., compressive forces) (F1, F2) against adjacent components of camera tower 100. In the non-limiting example, in the locked position, cam component 190 applies a first force (F1) against sidewall 130 of single, support armature 118. Additionally, adjustment component 184 applies a second force (F2), opposite the first force (F1), against outer shell 150, and more specifically sidewall portion 158, when positional adjustment assembly 164 is in the locked position. The applied forces on single, support armature 118 and outer shell 150 prevent a user from being able to adjust the height (H) and/or angular tilt (α) of outer shell 150, as well as maintain the current height (H) and angular tilt (α) of outer shell 150 when positional adjustment assembly 164 is in the locked position.

It is to be understood that the height (H) and angular tilt (α) of outer shell 150 for camera tower 100 can be adjusted independent of one another. That is, the height (H) of outer shell 150 can be adjusted independent of the angular tilt (α), and vice versa. As such, a user can adjust both the height (H) and angular tilt (α) of outer shell 150, or alternatively can adjust the height (H) or the angular tilt (α) of outer shell 150. Additionally, although discussed herein as only being able to adjust the height (H) and angular tilt (α) of outer shell 150 when positional adjustment assembly 164 is in the unlocked position, it is understood that in other non-limiting examples, the height (H) or angular tilt (α) of outer shell 150 can be adjusted when positional adjustment assembly 164 is in the locked positioned. For example, securing component 180 can be manipulated to adjust the angular tilt (α) of outer shell 150, as similarly discussed herein with respect to FIGS. 2A-2C, regardless of whether positional adjustment assembly 164 is in the locked or unlocked position. In this exemplary embodiment, positional adjustment assembly 164 can only lock and/or secure the height (H) of outer shell 150, while securing component 180 controls, and/or maintains the angular tilt (α) of outer shell 150.

FIG. 4 is a front view of tilt plate 274 for a positional adjustment assembly (not shown) for another non-limiting example of camera tower 100. As similarly discussed herein with respect to FIGS. 2A-2C, tilt plate 274 includes at least one tilt feature 276 that facilitates adjustment of the angular tilt of outer shell 150 for camera tower 100 during operation. In the non-limiting example shown, tilt feature 276 of tilt plate 274 includes a single, curved notch 299 formed on a surface of tilt plate 274. In the exemplary embodiment, curved notch 299 is formed and/or oriented such that during operation, the angular tilt for outer shell 150 can be adjusted between +30° and −30°. As such, each end of single, curved notch 299 angularly offset from one another by approximately 60°. In the non-limiting example shown in FIG. 4, single, curved notch 299 also provides improved and/or an increased number of obtainable angular tilts for outer shell 150. That is, and with comparison to tilt plate 174 (see, FIGS. 2A-2C) which allows for the angular tilt (α) to be adjusted in 15° increments, curved notch 299 provides the user the ability to adjust the angular tilt (α) of outer shell 150 to any angle ranging between +30° and −30°. A though discussed herein as ranging from +30° and −30°, it is understood that single, curved notch 299 can be larger, smaller, and/or include a distinct curvature to increase or decrease the angular tilt range achievable by outer shell 150.

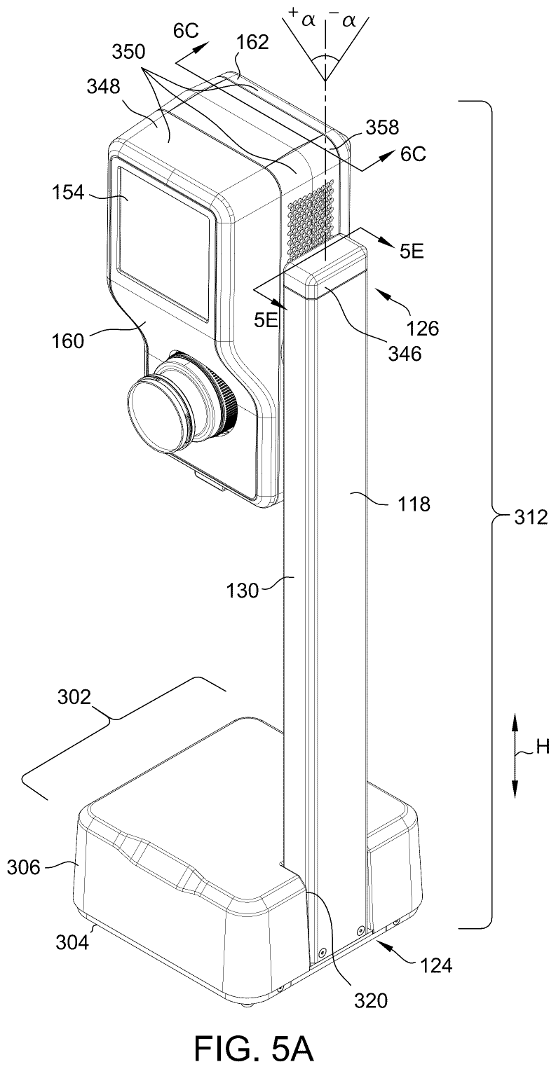

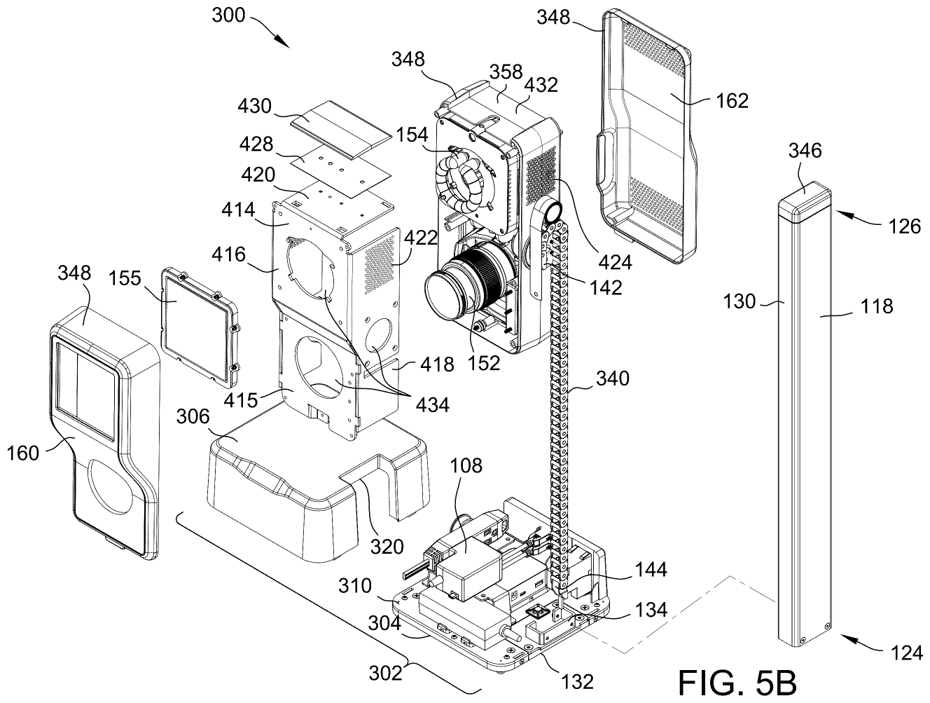

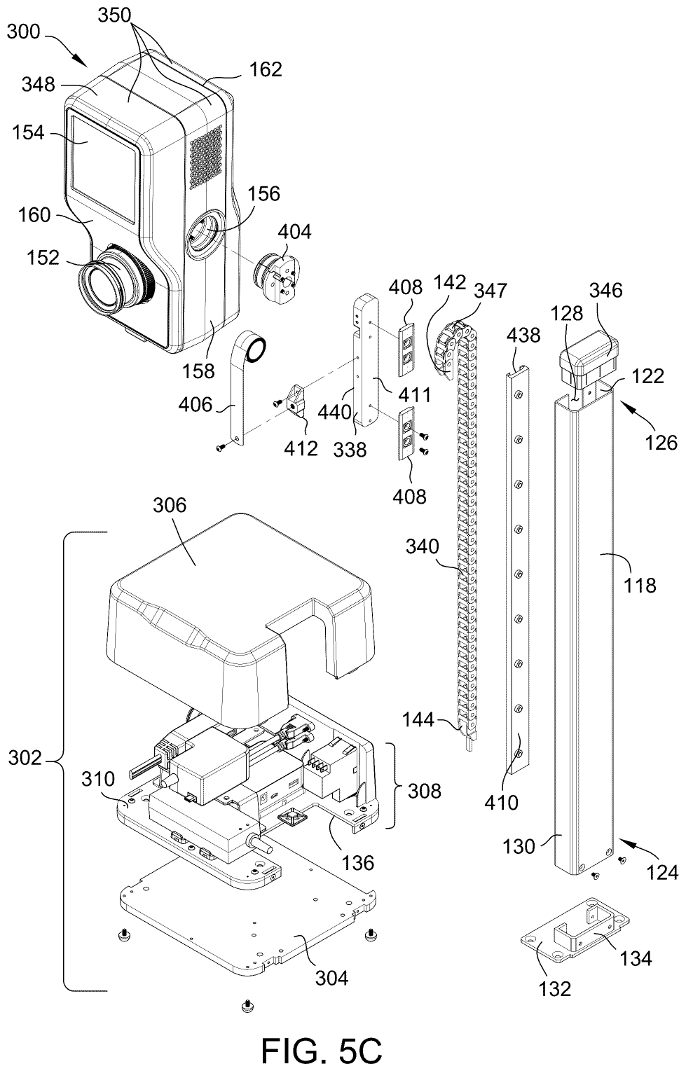

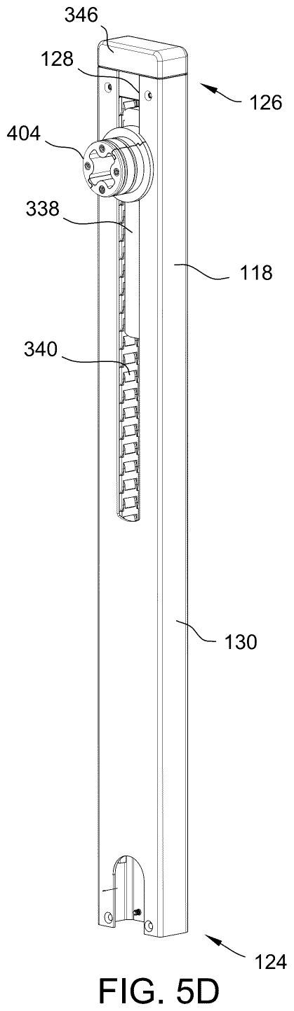

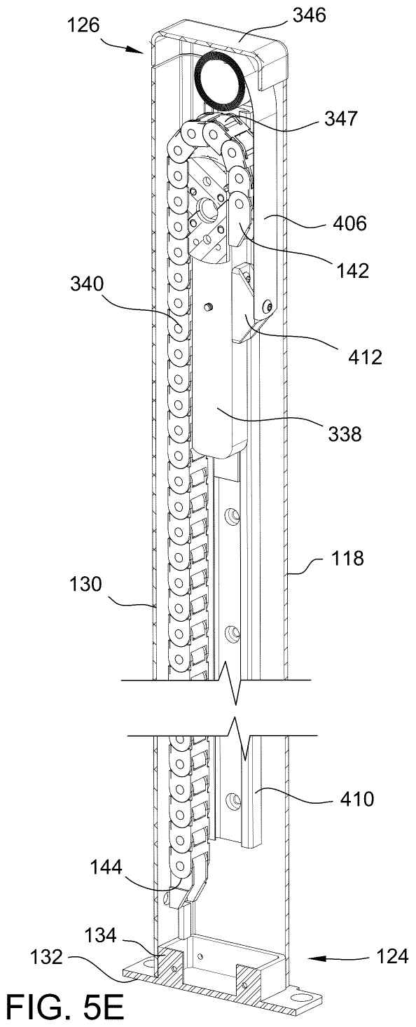

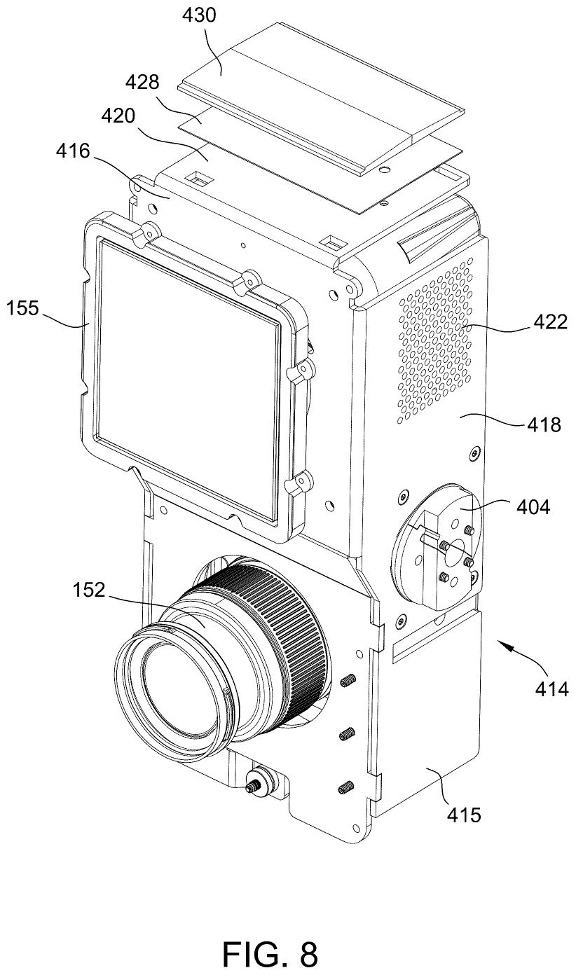

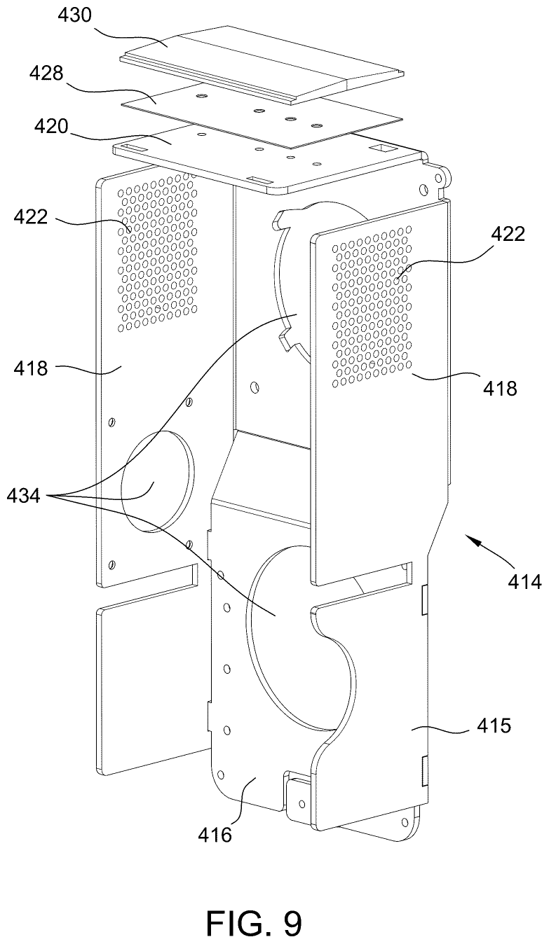

FIGS. 5A, 5B, 5C, 5D, 5E, 8 and 9 show various views of an alternative camera tower or camera tower system 300 (hereafter, “camera tower 300”). Camera tower 300 is similar to camera tower 100 shown in FIG. 1A and includes new components and operating mechanisms as will be discussed hereinafter. Elements in camera tower 300 that are the same as elements in camera tower 100 are labeled with the same element number. FIG. 5A is a perspective view of camera tower 300 and FIGS. 5B and 5C are partially exploded, perspective views of camera tower 300. Additionally, FIG. 5D is a perspective view of a support armature including some components of a positional adjustment assembly of the camera tower shown in FIG. 5A., while FIG. 5E is a cross-sectional, side view of a portion of camera tower 30 taken along line 5E-5E in FIG. 5A. FIG. 8 is a perspective view of a frame, or a heat spreader, of the camera tower shown in FIG. 5A with an exploded top portion. FIG. 9 is a partially exploded view of the heat spreader shown in FIG. 5F.

As discussed herein, portions of camera tower 300 are adjustable to alter the height and/or angular tilt of a camera for improving picture capturing capabilities, while reducing an overall footprint of camera tower 300. In one embodiment, the footprint of camera 300 is 8 inches by 8 inches, whereas prior camera towers have included bases that are 9 inches or more by 9 inches or more.

Camera tower 300 includes a base assembly 302. Base assembly 302 provides support and stabilizes camera tower 300 during operation. In non-limiting examples shown in FIGS. 5A-5C, base assembly 302 includes a bottom plate 304 positioned adjacent a surface (not shown) in which camera tower 300 is positioned on and/or over, and a cover 306 coupled to bottom plate 304. Bottom plate 304 is formed from any suitable material and/or component configured to support various components of camera tower 300 and/or provide stability to camera tower 300 during operation. For example, bottom plate 304 is formed from a material including, but not limited to, metal, metal alloy, steel, polymer, ceramic material, or the like.

Cover 306 is coupled to and/or positioned over or on bottom plate 304 to define a space between bottom plate 304 and cover 306 of base assembly 302. The space defined between cover 306 and bottom plate 304 can house and/or receive a plurality of components of camera tower 300. For example, and as shown in FIG. 5B, a plurality of electronic components 108 are positioned between bottom plate 304 and cover 306. M ore specifically, the plurality of electronic components 108 are disposed over and/or coupled to a substrate 310 coupled to and/or positioned on bottom plate 304, opposite cover 306. During operation of camera tower the plurality of electronic components 108 are substantially covered, enveloped, and/or protected by cover 306. The plurality of electronic components 108 of camera tower 300 can be formed as any suitable components to aid in the operation of camera tower 300. For example, the plurality of electronic components 108 can include, but are not limited to, a power supply or power converter, a memory device for storing images captured by a camera of camera tower 300, a device connection hub or multiport (e.g., universal serial bus (USB)), and similar electronic components. In exemplary embodiments, the device connection hub includes a plurality of USB and/or USB type-C ports for connecting a plurality of devices to camera tower 300.

In exemplary embodiments shown in FIGS. 5A and 5E, specifically, camera tower 300 also includes a camera mount assembly 312 coupled to base assembly 302. Camera mount assembly 312 includes a single, support armature 118 extending from base assembly 302. M ore specifically, single, support armature 118 extends substantially perpendicular from and/or is releasably coupled to bottom plate 304 of base assembly 302. As shown in FIGS. 5A and 5B, cover 306 of base assembly 302 includes a recess 320 for receiving and/or being disposed around at least a portion of single, support armature 118 when single, support armature 118 is coupled to and/or extending from base assembly 302. Single, support armature 118 is formed from any suitable material that is capable of supporting distinct components of camera mount assembly 312 for camera tower 300. For example, single support armature 118 is formed from a material including, but not limited to, metal, metal alloy, aluminum, polymer, ceramic material, or the like.

Single, support armature 118 of camera mount assembly 312 includes an opening 122 extending therethrough. That is, and in exemplary embodiments where single, support armature 118 is formed as a substantially tubular component, single, support armature 118 includes opening 122 extending therethrough and/or extending between a first end 124 and a second end 126 of single, support armature 118. Opening 122 formed in single, support armature 118 is configured to receive various components of camera tower 300, as discussed herein. Additionally, single, support armature 118 also includes a slot 128 formed in a sidewall 130. M ore specifically, and as shown in FIG. 5C, slot 128 is formed through at least a portion of sidewall 130 adjacent second end 126 of single, support armature 118. As discussed herein, slot 128 receives components of camera mount assembly 312 to facilitate the positional adjustment and/or movement of distinct portions of camera tower 300 during operation.

In exemplary embodiments, camera mount assembly 312 also includes a support plate 132 coupled to single, support armature 118. Support plate 132 is releasably coupled to first end 124 of single, support armature 118, opposite second end 126 and/or slot 128. For example, and as shown in FIGS. 5B and 5C, first end 124 of single, support armature 118 is releasably coupled and/or affixed to a bracket 134 included on and/or formed integral with support plate 132. Additionally, support plate 132 is releasably coupled to and/or positioned on bottom plate 304 of base assembly 302. In the non-limiting example shown in FIG. 5C, support plate 132 is positioned within, received by, and/or adjacent to a notch 136 formed in substrate 310 to facilitate the releasable coupling of support plate 132 directly to substrate 310 of base assembly 302. As discussed herein, releasably coupling support plate 132 to bottom plate 304 facilitates the complete assembling of camera mount assembly 312 separate from base assembly 302 and/or increases the ability to perform maintenance on different components of camera mount assembly 312 by uncoupling support plate 132 from bottom plate 304. Support plate 132 is releasably coupled to bottom plate 304 of base assembly 302 using any suitable coupling technique and/or mechanism. Additionally, single, support armature 118 is releasably coupled to bracket 134 of support plate 132 using any suitable coupling technique and/or coupling mechanism including, but not limited to, screws, nuts-and-bolts, snap fits, pins, and the like.

As shown in the exploded views of FIGS. 5B and 5C, and FIG. 5E, camera tower 300 includes an alternative slidable mount 338 positioned within opening 122 and coupled to a chain 340. Chain 340 is also disposed within and/or is positioned inside of opening 122 of support armature 118. In a non-limiting example shown in FIG. 5B, a first end 142 of chain 340 is coupled directly to a side 440 of slidable mount 338, while a second end 144 of chain 340, opposite first end 142, is coupled and/or affixed to armature sidewall 130 of armature 118. In other exemplary embodiments, second end 144 of chain 340 is fixed directly to support plate 132 and/or support armature 118, adjacent second end 126. Additionally, and as shown in FIG. 5E, chain 340 is wrapped around, and/or substantially bends around slidable mount 338 within camera tower 300. To facilitate the bending of chain 340, and/or to prevent slidable mount 338 and chain 340 from being removed from support armature 118 during operation, an end cap 346 is coupled to support armature 118. As discussed herein, chain 340, and more specifically first end 142 of chain 340, is configured to selectively move within single, support armature 118, in conjunction with slidable mount 338, in response to adjusting the height (H) of distinct components of camera mount assembly 112 relative to base assembly 102. That is, and as a result of first end 142 of chain 340 being coupled directly to slidable mount 338, first end 142, and adjacent portions of chain 340 are configured to selectively move, along with slidable mount 338, within single, support armature 118 when adjusting the height (H) of distinct components of camera mount assembly 112.

In one embodiment, chain 340 is formed as an energy chain.

Furthermore, chain 340 is configured to house, protect, and/or restrict movement of wires or physical electrical connections for the camera and/or flash component included within camera tower 300. In exemplary embodiments, chain 340 includes a break, discontinuity, and/or “zipper” 347 (hereafter, “zipper 347”) in a portion of each of the links forming chain 340. Zipper 347 of chain 340 provides access to an internal cavity defined by and/or within each link. For example, zipper 347 is formed on an outer portion of each link for chain 340. Zipper 347 provides improved and/or ease of access to the internal cavity defined by the links of chain 340, such that wires and/or electrical connections coupled to the camera and/or flash component and plurality of electronic components 108 housed in base assembly 302 can be disposed within and/or extend through support armature 118 within chain 340. Additionally, or alternatively, housing the wires of camera tower 300 within chain 340 substantially prevents and/or reduces the risk of the wires obstructing the movement of slidable mount 338 within single, support armature 118 during operation of camera tower 300, as discussed herein.

However, in alternative embodiments, chain 340 is formed from any suitable grouping mechanism and/or device that is configured to move within support armature 118 and/or housing wires for various components of camera tower 300, as discussed herein. Chain 340 is formed from any suitable material and/or component configured to move within support armature 118 during operation. For example, chain 340 is formed from a material including, but not limited to, metal, metal alloy, polymer, ceramic material, plastic, braided fibers/fibrous material, or the like.

As shown in FIGS. 5A-5C, camera mount assembly 312 also includes a camera housing 348 coupled to slidable mount 338. Camera housing 348 of camera mount assembly 312 is positioned adjacent single, support armature 118 of camera tower 300. In exemplary embodiments, camera housing 348 includes an outer shell 350 surrounding, circumscribing, and/or housing at least a portion of a camera 152 a flash device 154 and/or a flash protector 155, respectively. Outer shell 350 of camera housing 148 includes an aperture 156 formed therethrough. M ore specifically, and as shown in FIG. 5C, outer shell 350 includes a sidewall portion 358 including aperture 156 formed therethrough, where aperture 156 is substantially adjacent to and/or aligned with single, support armature 118. Additionally in the non-limiting example, outer shell 350 of camera housing 348 also includes a front portion 160 releasably coupled to sidewall portion 358, and a back portion 162 releasably coupled to sidewall portion 358, opposite front wall portion 160. Releasably coupling front portion 160 and/or back portion 162 of outer shell 350 provides increased access and/or ease of accessibility to camera 152 and/or flash device 154 to perform maintenance and/or exchange parts of components within camera tower 300 during operation. Outer shell 350 is formed from any suitable material that protects and/or supports camera 152 and/or flash device 154 during operation of camera tower 300.

As shown in FIGS. 5B, 8 and 9, camera tower 300 includes a frame 414 positioned within camera housing 348. In one embodiment, frame 414 is a heat spreader to help dissipate heat produced by flash device 154. In one embodiment, heat spreader 414 is positioned at least partially within sidewall portion 358. In this embodiment, heat spreader 414 is comprised of a metal or a metal alloy such as aluminum and is configured to draw heat from within the cavity of camera housing 348 and dissipate it through outer shell 350. H eat spreader 414 includes a front 416, a pair of sides 418 and a top 420. Sides 418 include a plurality of vents 422 that are positioned to be in flow communication with a plurality of vents 424 formed in sidewall portion 358 of outer shell 150. Back portion 162 of outer shell 150 also includes a plurality of vents 426 to provide additional heat dissipation from within outer shell 350. Heat spreader 414 further includes a thermal plate 428 that is connected to heat spreader frame support 415. A top plate 430 is connected to thermal plate 428 and forms a top portion of camera tower 300. H eat spreader frame support 415 is positioned within outer shell 350 with the exception of heat spreader top 420. Heat spreader top 420 is positioned on an outer surface of a top 432 of sidewall portion 358 and as such, top plate 430 forms the top portion of camera tower 300 to release heat externally. Heat spreader 414 includes a plurality of apertures 434 to accommodate camera 152, flash device 154 and hub assembly 404.

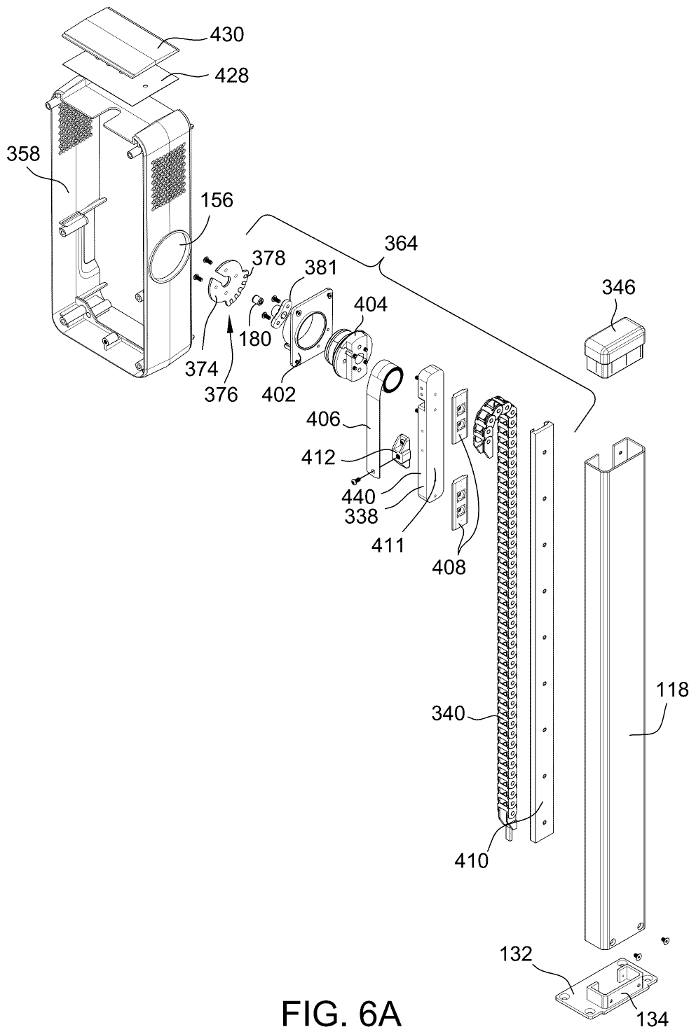

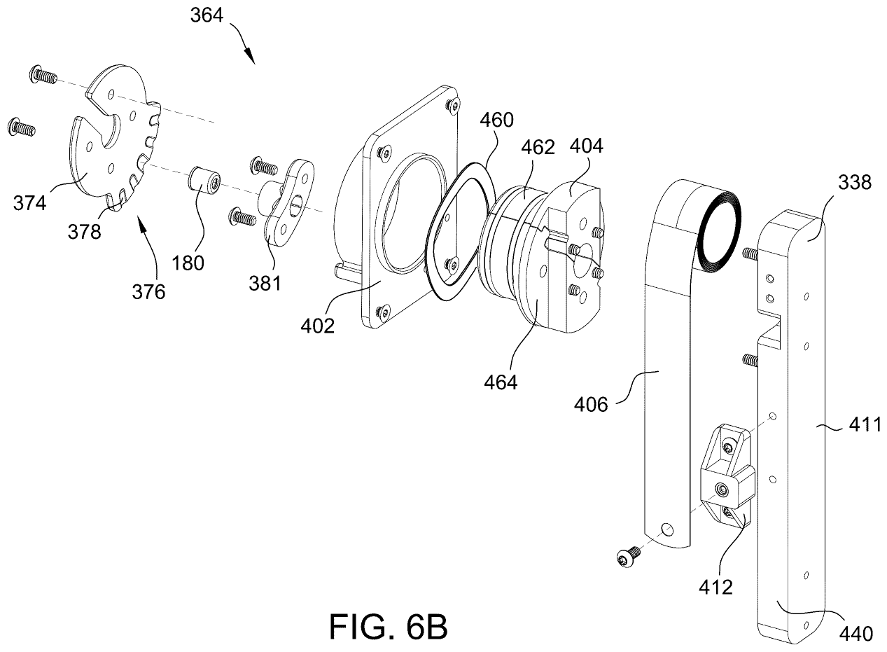

Camera mount assembly 312 also includes a positional adjustment assembly 364 coupled to camera housing 348. As discussed herein, positional adjustment assembly 364 is configured to adjust the height (H) of camera housing 348 relative to base assembly 302, and/or adjust angular tilt (α) (see, FIG. 5A) relative to single, support armature 118 during operation or use of camera tower 300. Positional adjustment assembly 364 includes a tilt plate 374. Tilt plate 374 is positioned and/or disposed within internal cavity (C) (see, FIG. 2C) defined by camera housing 348, adjacent to and substantially aligned with aperture 156 formed through sidewall portion 358. Tilt plate 374 is configured to and/or facilitates the angular tilt of camera housing 348. That is, tilt plate 374 includes at least one tilt feature 376 that facilitates adjustment of the angular tilt of camera tower 300 during operation. In the non-limiting example shown in FIGS. 6A and 6B, tilt feature 376 includes a plurality of fanned notches 378 formed on a surface of tilt plate 374. In the exemplary embodiment, tilt plate 374 includes five (5) distinct notches 378 spaced apart and/or oriented with respect to one another such that during operation, the angular tilt for camera housing 348 can be adjusted between +30 degrees and −30 degrees. As such, each adjacent notch 378 may determine, define, and/or distinguish a 15 degree angular tilt difference for camera housing 348, where the third or middle notch 378 defines and/or positions camera housing in a 0 degree angular tilt when engaged during operation of camera tower 300. Although five (5) notches 378 are shown, it is to be understood that tilt plate 374 can include more or less notches forming tilt feature 376. Tilt plate 374 is formed from any suitable material that facilitates the adjustment of the angular tilt of camera housing 348, as discussed herein. For example, tilt plate 374 is formed from a material including, but not limited to, metal, metal alloy, aluminum, polymers, ceramics, fibrous materials, and the like. Additionally, although discussed herein as ranging from +30 degrees and −30 degrees and/or being adjustable by 15 degree increments, it is to be understood that the plurality of notches 378 included in tilt plate 374 can be larger, smaller, and/or include a distinct spacing to increase or decrease the angular tilt range achievable by outer shell 350.

To secure and/or maintain the angular tilt (α) of camera housing 348, camera housing 348 includes additional components to engage and/or interact with tilt plate 374. For example, and as shown in FIGS. 6A and 6B, camera housing 348 includes securing component 180 coupled to housing outer shell 350. M ore specifically, securing component 180 is positioned within and/or extends from a bracket 381 that is secured to a hub mount 402. Hub mount 402 is mounted to a side 418 of heat spreader frame support 415 (shown in FIG. 5B) at aperture 156. Securing component 180 extends toward tilt plate 374 and is substantially aligned with tilt feature 376 of tilt plate 374. In the exemplary embodiment shown in FIG. 6B, securing component 180 is configured to contact tilt feature 376, and more specifically each of the plurality of fanned notches 378, included in tilt plate 374 to secure and/or maintain outer shell 350 at a desired angular tilt (α) during operation of camera tower 300. Additionally, securing component 180 is also formed as any suitable component, apparatus, and/or device to facilitate the adjustment between distinct angles for the angular tilt (α) of outer shell 350 during operation of camera tower 300.

In non-limiting examples, securing component 180 can include a spring loaded roller ball that is configured to be positioned within and/or engage the plurality of notches 378 included in tilt plate 374. That is, the roller ball can be disposed within and/or contact one of the plurality of notches 378 in tilt plate 374 to maintain and/or secure outer shell 350 in a desired angular tilt (α), dependent upon the specific notch 378. Additionally, roller ball can be “rolled out of” and/or at least partially compressed to roll over portions of tilt plate 374 formed between each of the plurality of notches 378 when adjusting the angular tilt (α) of outer shell 350. Additionally, securing component 180 provides tactile feedback (e.g., “clicks”) to the user as they adjust the angular tilt (α) of outer shell 350 during operation. Although discussed herein as spring-loaded roller ball, securing component 180 can be formed as any suitable device, mechanism, and/or apparatus that is configured to facilitate the adjusting and maintaining of the angular tilt (a) of outer shell 350 during operation of camera tower 300.

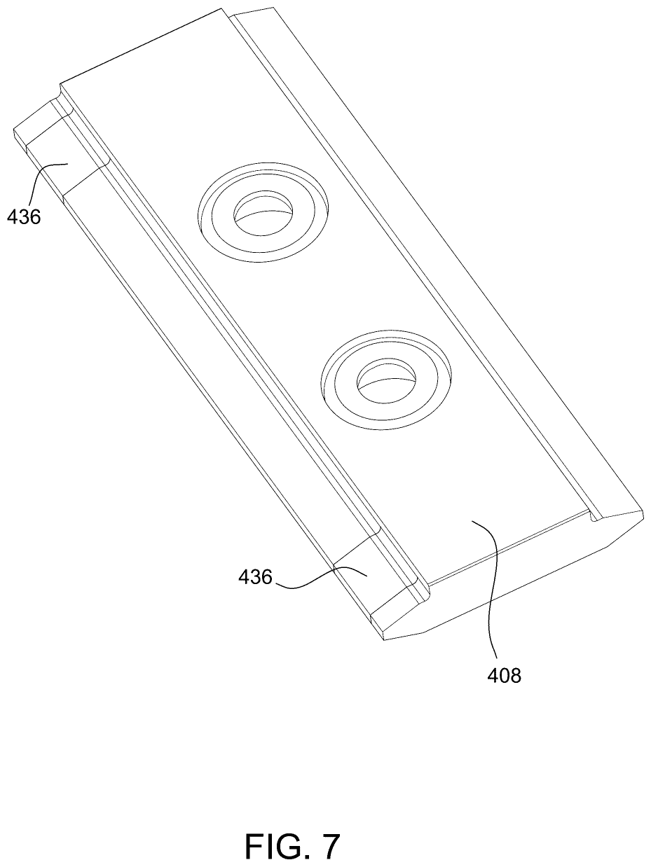

Positional adjustment assembly 364 also includes a hub assembly 404, a spring component 406, a pair of friction slides 408 and a rail 410 to adjust height. In one embodiment, spring component, (also referred to as first spring component) or spring 406 is a constant force spring that is mounted adjacent to and above chain 340 and is connected to side 440 of slidable mount 338 with a mount bracket 412. Mount bracket 412 is attached to one end of constant force spring 406 and to side 440 of slidable mount 338. Friction slides 408 are attached to a back 411 of slidable mount 338 and are positioned within rail 410. In one embodiment, two friction slides are connected to slidable mount 338. In this embodiment, and as shown in more detail in FIG. 7, friction slides 408 each include two spring pads 436 on one side of friction slide 408. A spring (not shown) within friction slide 408 forces spring pads 436 away from friction slide 408. Friction slides 408 are positioned within rail 410 by compressing spring pads 436 towards friction slide 408 and then sliding them through an opening 438 formed at one end of rail 410. This compression of friction spring pads 436 creates a force that opposes movement of positional adjustment assembly 364, and camera housing outer shell 350 along slot 128 until a greater force is exerted on camera housing outer shell 350. In one embodiment, the resistance force provided by the combination of friction slides 408 and spring 406 is between about three and ten pounds. In other embodiments, the friction slides can be set to provide other amounts of force resistance. Slidable mount 338, mount bracket 412, friction sliders 408, rail 410 and chain 340 are positioned, and are retained, within support armature 118.

In one embodiment, the combination of spring pads 436, rail opening 438, spring 406, slidable mount 338 and friction sliders 408 constitutes an adjustment component of positional adjustment assembly 364. This adjustment component provides a resistive force and remains stationary in a locked configuration until a force greater than the resistive force is applied to camera housing 348, such as by a user of camera tower 300. Once a force greater than the resistive force is applied to camera housing 348, camera housing 348 enters an unlocked configuration and moves along support armature 118 until the force applied to camera housing 348 is less than the resistive force and camera housing 348 again enters the locked configuration.

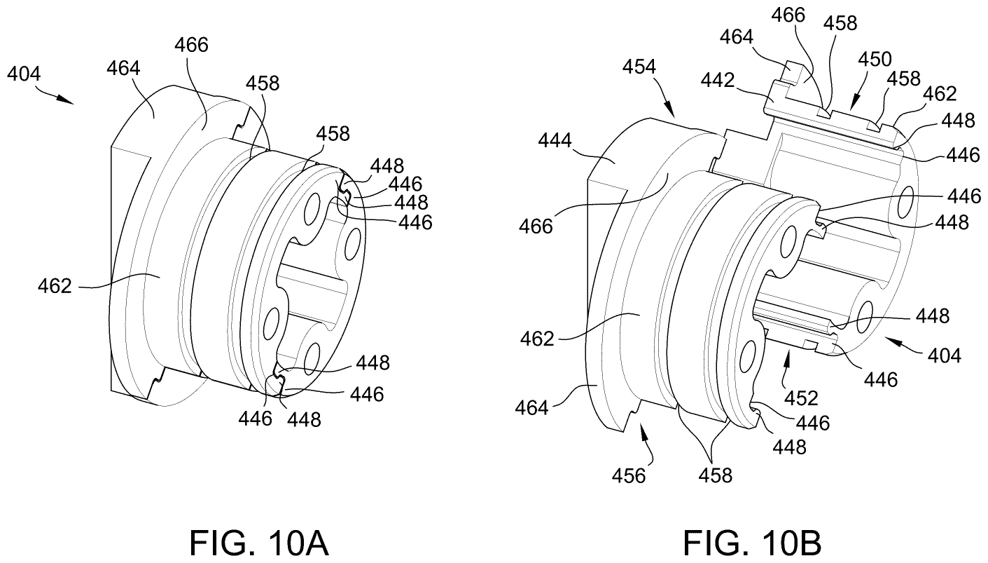

As shown in more detail in FIGS. 10A and 10B, hub assembly 404 includes a first portion 442 and a second portion 444 that interfit together with a tongue and groove structure. M ore specifically, each portion 442, 444 includes an outer recess 446 and an inner rail 448 on one end and an outer rail 448 and an inner recess 446 on the other end. In one embodiment, first portion 442 has a first side 450 having outer rail 448 and inner recess 446 that interfits with a first side 454 of second portion 444 that has outer recess 446 and inner rail 448. Similarly, first portion 442 has a second side 452 having outer recess 446 and inner rail 448 that interfits with a second side 456 of second portion 444 that has outer rail 448 and inner recess 446.

Hub assembly 404 includes an inner portion 462 and an outer portion 464. Inner portion 462 extends through aperture 156 and outer portion 464 remains outside of outer shell 350. Inner portion includes a pair of grooves 458 configured to receive springs. As shown in FIG. 6B, a disc spring component (also referred to as second spring component), or disc spring 460 is positioned over inner portion 462 and between an inner surface 466 of outer portion 464 and a side wall 418 of heater spreader 414 surrounding aperture 156. In one embodiment, disc spring 460 is a wavy disc spring. Disc spring 460 provides additional resistance to movement of camera housing 348 relatively to support armature 118 and in particular tilting.

As discussed herein, wires (not shown) connected to camera 152 and/or flash device 154 are at least partially housed within chain 340. The wires then pass through hub assembly 404, hub mount 402, aperture 156, and tilt plate 374. Wires are mechanically and/or electrically connected to camera 152 and/or flash device 154 within outer shell 350 to provide power and/or transmit data/signals between the plurality of electronic components 108 and camera 152/flash device 154 during operation of camera tower 300. An advantage of hub assembly having two portions 442 and 444 is that portions 442 and 444 can be assembled around the wires thus enabling the wires to have a larger end that can extend into camera mount assembly 312.

Additionally, or alternatively, the angular tilt (α)(see, FIG. 5A) of outer shell 350 can also be adjusted. That is, a rotational force (e.g., in and out of the page) can be applied to outer shell 350 to adjust the angular tilt (α). As discussed herein, tilt plate 374 and securing mechanism facilitate the adjusting and/or maintaining of the angular tilt (a) of outer shell 350 during operation of camera tower 300. It is to be understood that the height (H) and angular tilt (α) of outer shell 350 for camera tower 300 can be adjusted independent of one another. That is, the height (H) of outer shell 350 can be adjusted independent of the angular tilt (α), and vice versa. As such, a user can adjust both the height (H) and angular tilt (α) of outer shell 350, or alternatively can adjust the height (H) or the angular tilt (α) of outer shell 350.

In the foregoing specification and the claims that follow, a number of terms are referenced that have the following meanings.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here, and throughout the specification and claims, range limitations may be combined or interchanged. Such ranges are identified and include all the sub-ranges contained therein unless context or language indicates otherwise.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is generally not intended to imply certain embodiments require at least one of X, at least one of Y, and at least one of Z to each be present. Additionally, conjunctive language such as the phrase “at least one of X, Y, and Z,” unless specifically stated otherwise, should be understood to mean any combination of at least one of X, at least one of Y, and at least one of Z.

The assemblies, apparatuses, and/or systems described herein are not limited to the specific embodiments described herein, but rather, components of the systems and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A camera mount assembly comprising:
a support armature;
a frame including an aperture formed therethrough;
a camera housing connected to said support armature and configured to at least partially surround said frame, said camera housing including an aperture formed therethrough; and
a positional adjustment assembly coupled to said frame, said positional adjustment assembly including:
a hub assembly comprising an inner portion and an outer portion having an inner surface, said inner portion extending at least partially through the apertures of said frame and the camera housing; and
a first spring component positioned at least partially within said support armature and configured to resist movement of said frame and said camera housing along said support armature.

2. The camera mount assembly of claim 1, wherein said positional adjustment assembly is positioned at least partially within said support armature.

3. The camera mount assembly of claim 1, wherein said positional adjustment assembly further includes a second spring component positioned on said hub assembly inner portion, said second spring component contacting said frame and said hub assembly second portion inner surface.

4. The camera mount assembly of claim 3, wherein said second spring component is a disc spring.

5. The camera mount assembly of claim 1, wherein said frame comprises a heat spreader including a heat spreader frame, a thermal plate and a top plate.

6. The camera mount assembly of claim 5, wherein said camera housing includes a sidewall portion having a top, said heat spreader frame is positioned at least partially within said camera housing sidewall portion, said thermal plate is connected to said heat spreader frame top, and said top plate is connected to said thermal plate and forms an outer surface of said camera mount assembly.

7. The camera mount assembly of claim 1, wherein said hub assembly includes a split hub including a first portion and a separate second portion, wherein said first portion interfits with said second portion.

8. The camera mount assembly of claim 1, wherein said positional adjustment assembly includes at least one friction slider and a slidable mount having a first side and a second side, wherein said hub assembly is connected to said slidable mount first side, and said at least one friction slider is connected to said slidable mount second side.

9. The camera mount assembly of claim 8, wherein said slidable mount includes a third side having a bracket and wherein said first spring component includes a first end, wherein said first spring component first end is connected to said slidable mount third side bracket.

10. The camera mount assembly of claim 8, wherein said positional adjustment assembly includes a rail positioned at least partially within said support armature, wherein said at least one friction slider is positioned within said rail.

11. The camera mount assembly of claim 1, wherein said positional adjustment assembly is configured to adjust a height and an angular tilt of said camera housing in response to a force being applied to said camera housing.

12. The camera mount assembly of claim 9, wherein said positional adjustment assembly further includes a chain having a first end, said chain first end connected to said slidable mount third side.

13. The camera mount assembly of claim 12, wherein said chain is positioned at least partially within said support armature.

14. A camera tower, comprising:
a base assembly including a bottom plate; and
a camera mount assembly comprising:
a support armature;
a frame including an aperture formed therethrough;
a camera housing connected to said support armature and configured to at least partially surround said frame, said camera housing including an aperture formed therethrough; and
a positional adjustment assembly coupled to said frame, said positional adjustment assembly including:
a hub assembly comprising an inner portion, an outer portion having an inner surface, and a disc spring, said inner portion extending at least partially through the aperture of said heat spreader and the camera housing, said disc spring contacting said outer portion inner surface and said frame; and
a spring component positioned at least partially within said support armature and configured to resist movement of said frame and said camera housing along said support armature.

15. The camera tower of claim 14, wherein said frame includes a heat spreader including a heat spreader frame, a thermal plate and a top plate, and wherein said camera housing includes a sidewall portion having a top, said heat spreader frame positioned at least partially within said camera housing sidewall portion, said thermal plate connected to said heat spreader frame, and said top plate is connected to said thermal plate and forms an outer surface of the camera mount assembly.

16. The camera tower of claim 14, wherein said hub assembly includes a split hub including a first portion and an identical second portion, wherein said first portion interfits with said second portion.

17. The camera tower of claim 14, wherein said positional adjustment assembly includes at least one friction slider and a slidable mount having a first side and a second side, wherein said hub assembly is connected to said slidable mount first side, and said at least one friction slider is connected to said slidable mount second side.

18. The camera tower of claim 17, wherein said slidable mount includes a third side having a bracket, and wherein said spring component includes a first end, said spring component first end connected to said slidable mount third side bracket.

19. The camera tower of claim 18, wherein said positional adjustment assembly further includes a chain having a first end, said chain first end connected to said slidable mount third side adjacent said spring component.

20. The camera tower of claim 14, wherein said positional adjustment assembly further comprises a tilt plate including a plurality of fanned notches formed on a surface thereof.
